(19) United States
(12) Patent Application Publication
(10) Pub. No.: US 2003/0018814 A1
(43) Pub. Date: Jan. 23, 2003

(54) Method of letting a single LAN port voice over IP device have network address translation function

(76) Inventors: Yung-Chung Kao, Hsinchu (TW); Ching-Chung Chiang, Hsinchu (TW); Wei-Che Yu, Hsinchu (TW)

Correspondence Address: BACON & THOMAS, PLLC, 625 SLATERS LANE, FOURTH FLOOR, ALEXANDRIA, VA, 22314

(21) Appl. No.: 09/894,129

(22) Filed: Jun. 29, 2001

(51) Int. Cl. G06F 15/16

(52) U.S. Cl. 709/245

(57) ABSTRACT

A method of letting a single LAN port VoIP (voice over IP) device have network address translation function by means of the application of NAT (network address translation) technique of translating the private IP address of an organization into a global IP address for use in the Internet to a VoIP device having a single LAN port to let multiple handsets of the VoIP device use a global IP address in the Internet to connect the Internet through a network apparatus and to perform Internet telephone communication through the VoIP address.

### BACKGROUND OF THE INVENTION

The present invention relates to an Internet communication method and, more specifically, to such a method that applies NAT (network address translation) technique of translating the private IP address of an organization into a global IP address for use in the Internet to a VoIP device having a single LAN port to let multiple handsets of the VoIP device use a global IP address in the Internet to connect the Internet through a network apparatus and to perform Internet telephone communication.

Internet phones have become more and more popularly accepted for the advantage of low payment for long distance call and international call. A variety of VoIP (Voice Over IP) devices have been disclosed for long distance call and international call through the Internet. According to investigations, more than 70% of conventional telephone users show interest in using a VoIP device to make a long distance or international call. This big amount of communication users and demand forces VoIP device managers (for example, call agents) to face the following problems:

(1) Insufficient of IP address.

(2) Because current VoIP devices have only one LAN port, multiple persons of a company or organization cannot make communication through a VoIP device at the same time.

(3) Because current VoIP devices provide only one global IP address, multiple persons of a company or organization cannot communicate other VoIP devices through the global IP address of the company or organization's VoIP device at the same time.

(4) Current network apparatus with NAT function (for example, router) are to be used in apparatus having at least two network interfaces and I/O ports in which one I/O port is for external connection, and the other I/O port is for internal connection. When applying the NAT function to a regular VoIP device having only one LAN port, the VoIP device must be modified to have at least two LAN ports.

### SUMMARY OF THE INVENTION

The invention has been accomplished under the circumstances in view. The invention applies NAT (network address translation) technique of translating the private IP address of an organization into a global IP address for use in the Internet to a VoIP device having a single LAN port to let multiple handsets of the VoIP device use a global IP address in the Internet to connect the Internet through a network apparatus and to perform Internet telephone communication.

According to the present invention, a virtual IP interface is added to a VoIP device having a single LAN port, so that the virtual IP interface can use NAT technique to let the users of the enterprise or organization in which the VoIP device is installed set a global IP address through the virtual IP interface. Thus, the virtual IP interface converts the source IP address and port number of each outward packet into the global IP address and another port number set in the virtual IP interface, and then stores the conversion in a NAT conversion table in the NAT interface, and then sends the data to the single LAN port through the physical IP interface for connection to the Internet subject to the global IP address.

### BRIEF DESCRIPTION OF THE DRAWINGS

FIG. 1 is a block diagram of a communication system according to the present invention.

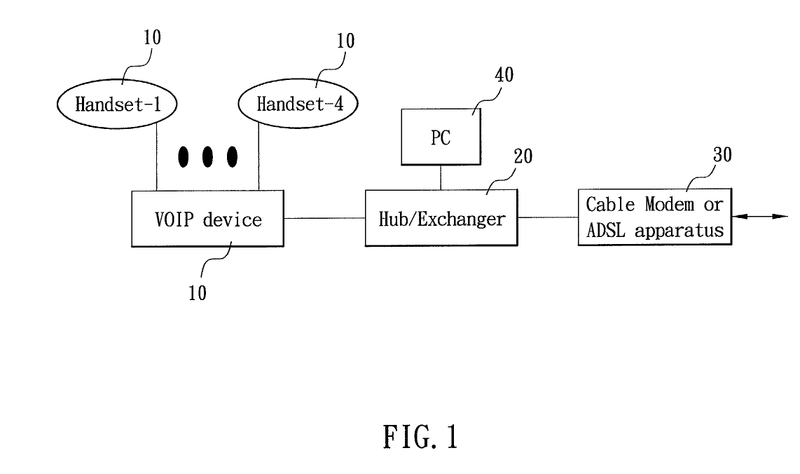

FIG. 2 is a block diagram of a communication interface according to the present invention.

FIG. 3 is a block diagram explaining the network address translation processing procedure of the VoIP device upon receipt of an outward dispatching packet according to the present invention.

FIG. 4 is a block diagram explaining the network address translation processing procedure of the VoIP device upon receipt of an inward dispatching packet according to the present invention.

### DETAILED DESCRIPTION OF THE PREFERRED EMBODIMENT

Following fast development of Internet applications, global IP addresses for network apparatus become insufficient. In order to conquer this problem, RFC (Internet Requests for Comments) 1918 and RFC1631 define a private IP address and NAT (network address translation technique, enabling a private enterprise or organization to use the private IP address as its internal network's IP address without filing an application to the Internet server. Because the private IP address is simply used for the connection of the internal computer network of the enterprise or organization, the enterprise or organization is responsible of prohibiting the private IP address from being transferred to an external network system outside the enterprise or organization. Therefore, external network systems outside the enterprise or organization cannot obtain the private IP address, and only the computers in the enterprise or organization can repeatedly use the private IP address. This measure greatly reduces the demand for global IP address. However, because the private IP address cannot let the computers in the enterprise or organization be connected to the Internet, the private IP address must be translated through NAT so that the computers in the enterprise or organization can use a common global IP address to connect to the Internet.

The invention applies the aforesaid NAT technique to a single LAN port VoIP device 10 to translate the private IP address into a global IP address, enabling multiple handsets 11 of the enterprise or organization to use the global IP address to connect to the Internet through a network apparatus 30 (cable modem or ADSL modem). The computers 40 that are connected to the switching hub 20 between the network apparatus 30 and the VoIP 10 can simultaneously use the global IP address to connect to the Internet through the network apparatus 30.

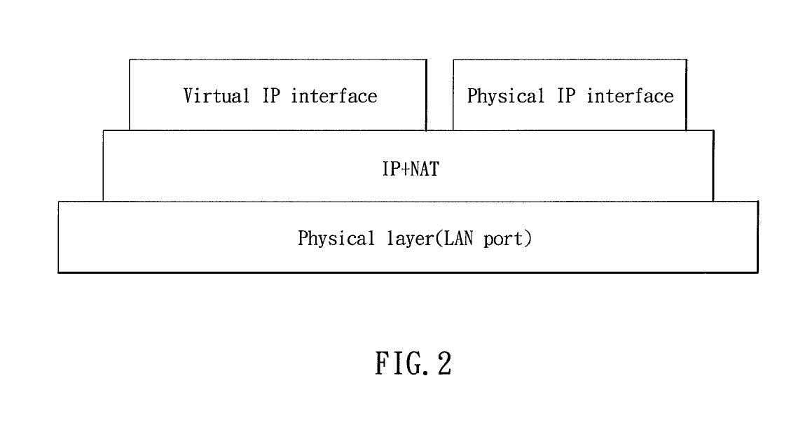

According to the present invention, the VoIP device 10 comprises two IP interfaces, as shown in FIG. 2. One of the two IP interfaces of the VoIP device 10 is a virtual IP interface that uses NAT technique to let the internal users of the enterprise or organization set a global IP address through the virtual IP interface. The other IP interface is the physical IP interface of the VoIP device for enabling the user to set a private IP address for use inside the enterprise or organization.

Upon receipt of an outward packet from the inside of the enterprise or organization, the physical IP interface of the VoIP device uses its NAT function to convert the source IP address and port number of the outward packet into the global IP address and another port number set in the virtual IP interface, and stores the conversion in a NAT conversion table in the NAT interface. The said another port number is given by NAT. Thereafter, the physical IP interface of the VoIP device sends the converted global IP address and port number to the single LAN port of the VoIP device, enabling the VoIPdevice to connect the Internet through its single LAN port subject to the global IP address.

Further, upon receipt of an inward packet from the outside of the enterprise or organization by the physical IP interface of the VoIP device, the virtual IP interface checks its internal NAT conversion table if there is data (for example, source IP address, source port number, destination IP address, and destination port number) in the NAT conversion table related to the inward packet. If the related data exists in the NAT conversion table, the virtual IP interface changes the destination IP address and destination port number of the inward packet back into the private IP address and port number for use internal use in the enterprise or organization, and then sends the data through the physical IP interface to the single LAN port of the VoIP device, enabling the packet message to be transmitted from the Internet through the single LAN port to the handsets on the VoIP device.

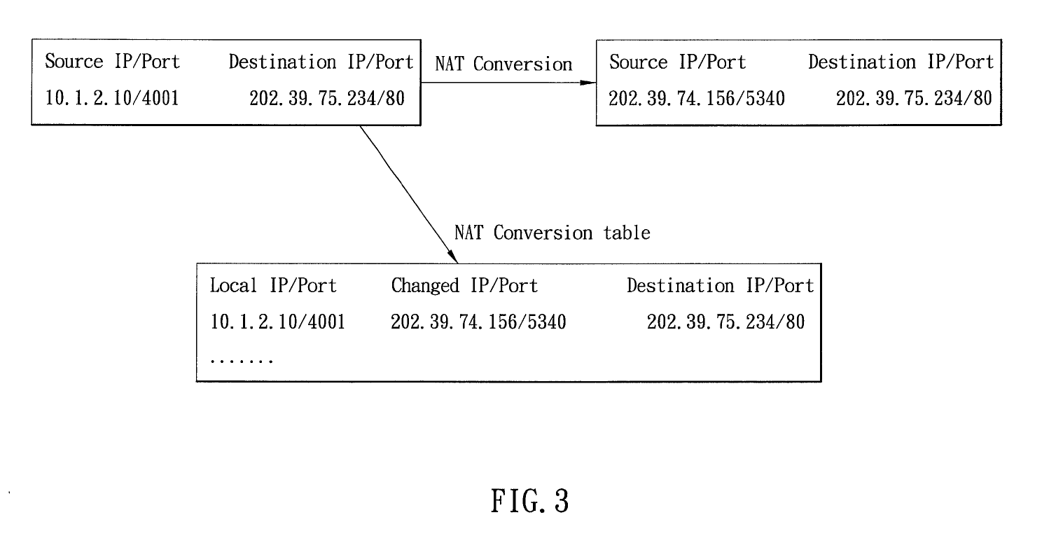

In one embodiment of the present invention as shown in FIG. 3, the IP address of the physical IP interface of the VoIP device is 10.1.2.10, the IP address of the virtual IP interface is 202.39.74.156. The virtual IP interface is capable of receiving outward packets of IP address range within 10.1.2.5˜10.1.2.253. Therefore, when the VoIP device received an outward packet and checked its source IP address/port number 10.1.2.10/4001 and its destination IP address/port number 202.39.75.234/80, the virtual IP interface immediately converts the source IP address/port number into the global IP address 202.39.74.156/5340 set in the virtual IP interface, and then builds up a NAT conversion table in the NAT interface and stores the conversion in the NAT conversion table, and then the virtual IP interface corrects the content of the packet subject to the change of IP address and figures out checksum again. Thereafter, the virtual IP interface transmits the packet to the single LAN port, enabling the VoIP device to transmit the packet to the Internet through the single LAN port subject to the global IP address.

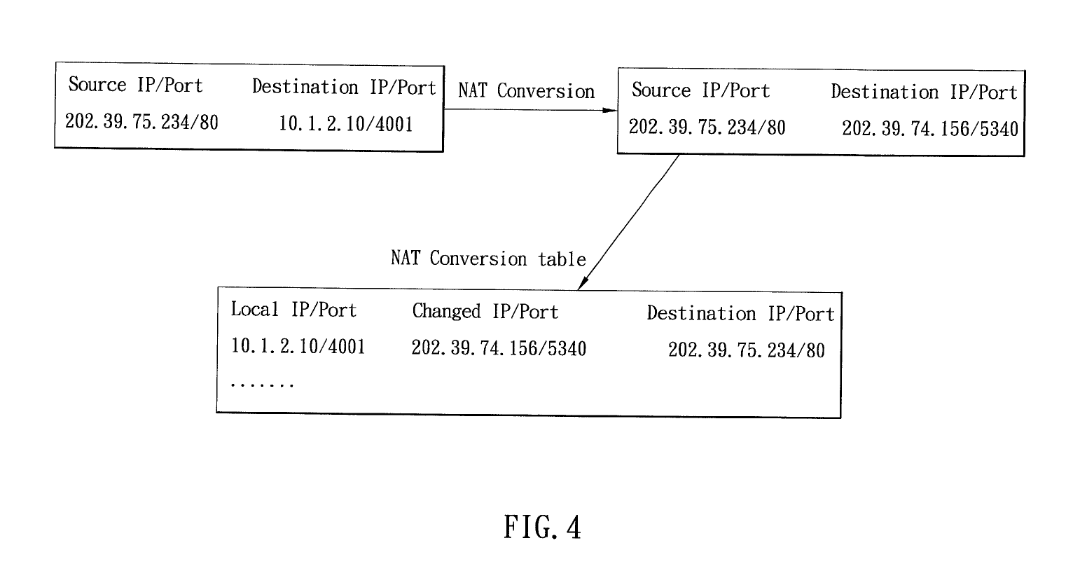

Referring to FIG. 4, when the VoIP device received an inward packet of source IP address/port number 202.39.75.234/80 and destination IP address/port number 202.39.74.156/5340, the virtual IP interface immediately searches the NAT conversion table to check if the same destination IP address/port number exists in the NAT conversion table or not, and then converts destination IP address/port number into the private IP address/port number 10.1.2.10/4001 for use inside the enterprise or organization, and then corrects the content of the packet subject to the change of IP address, and then transmits the packet to the single LAN port, enabling the handset of the VoIP device to receive the packet from the Internet through the single LAN port.

Thus, the VoIP device can use NAT protocol through its single LAN port to match with network apparatus (cable modem or ADSL modem), for enabling multiple handsets in the enterprise or organization to simultaneously use the VoIP device to perform Internet telephone communication, and also for enabling multiple personal computers to simultaneously use a legal global IP address to connect the Internet.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A method of letting a single LAN port VoIP (voice over IP) device have network address translation function by means of the application of NAT (network address translation) technique of translating the private IP address of an organization into a global IP address for use in the Internet to a VoIP device having a single LAN port to let multiple handsets of said VoIP device use a global IP address in the Internet to connect the Internet through a network apparatus and to perform Internet telephone communication through said VoIP address.

2. The method of letting a single LAN port VoIP (voice over IP) device have network address translation function as claimed in claim 1 wherein said VoIP device comprises a virtual IP interface that uses NAT technique to set a global IP address, and a physical IP interface adapted to set a private IP address for use inside the organization in which said VoIP device is installed.

3. The method of letting a single LAN port VoIP (voice over IP) device have network address translation function as claimed in claim 1 wherein said VoIP device comprises a NAT conversion table adapted to store translation data of private IP address to global IP address.

4. The method of letting a single LAN port VoIP (voice over IP) device have network address translation function as claimed in claim 3 wherein upon receipt of an outward packet from the inside of the organization in which said VoIP device is installed, the physical IP interface of said VoIP device uses the NAT function to convert the source IP address and port number of the outward packet into the global IP address and another port number set in said virtual IP interface, and then stores the conversion in said NAT conversion table, said another port number being given by NAT, and then said physical IP interface sends the converted global IP address and port number to the single LAN port of said VoIP device, enabling said VoIPdevice to connect the Internet through the single LAN port thereof subject to the global IP address.

5. The method of letting a single LAN port VoIP (voice over IP) device have network address translation function as claimed in claim 3 wherein upon receipt of an inward packet from the outside of the organization by said physical IP interface, said virtual IP interface checks the internal NAT conversion table if there is data related to the inward packet, and then said virtual IP interface changes the destination IP address and destination port number of the inward packet back into the private IP address and port number for use internal use in the enterprise or organization, if the related data exists in the NAT conversion table, and then sends the data through said physical IP interface to the single LAN port of said VoIP device, enabling the packet message to be transmitted from the Internet through the single LAN port to the handsets of said VoIP device.
